(19) United States
(12) Patent Application Publication
(10) Pub. No.: US 2026/0163490 A1
(43) Pub. Date: Jun. 11, 2026

(54) ACTIVE DUAL OUTPUT BUCK CONVERTER

(71) Applicant: Raytheon Company, Arlington, VA (US)

(72) Inventors: John R. Stowell, Sahuarita, AZ (US); Alden Alviar, Tucson, AZ (US); Chris Kavourinos, Tucson, AZ (US); Del Eric Stroud, Oro Valley, AZ (US)

(21) Appl. No.: 19/414,661

(22) Filed: Dec. 10, 2025

Related U.S. Application Data
(60) Provisional application No. 63/730,217, filed on Dec. 10, 2024.

(51) Int. Cl. H02M 3/335; H02M 1/08; H02M 3/00

(52) U.S. Cl. CPC H02M 3/33561; H02M 1/08; H02M 3/003; H02M 3/33569

(57) ABSTRACT

An active dual output buck converter includes an alternating current (DC) input configured to be connected to an DC power supply. A first switch connects the DC input to a first node. A second switch connects the first node to a return node. The second switch is an active AC switch. An inductor connects the first node to a positive output node. A diode connects the first node to a negative output node. A duty cycle of the positive output node is controlled by a duty cycle of the first switch and a second duty cycle of the negative output node is controlled by a duty cycle of the second switch.

### CROSS-REFERENCE TO RELATED APPLICATIONS

This application claims the benefit of U.S. Provisional Application No. 63/730,217 filed Dec. 10, 2024, the disclosure of which is incorporated herein by reference in its entirety.

### BACKGROUND

The present disclosure relates to direct current (DC) to direct current (DC) power converters, and more specifically to a singular DC to DC buck converter topology providing positive and negative voltage outputs.

Electrically driven components, such as sensors, can require DC power sources in order to operate. Such components are referred to as DC components. In some cases, when a DC voltage is provided, the power is converted into a different DC form using a power converter. Typical DC to DC power converters receive a power form and provide a different DC voltage rail and with respect to a return node.

Some electrically driven components, such as operational amplifiers (op-amps) require both a positive DC power and a negative DC power to provide the functions for which they are designed. In order to provide the negative DC power, conventional systems use an inverting boost converter to receive the DC input power signal and provide the negative DC voltage rail.

### SUMMARY

According to one embodiment, an active dual output buck converter includes an direct current (DC) input configured to be connected to an DC power source, a first switch connecting the DC input to a first node, a second switch connecting the first node to a return node, wherein the second switch is an active AC switch, an inductor connecting the first node to a positive output node, a diode connecting the first node to a negative output node, and wherein a duty cycle of the positive output node is controlled by a duty cycle of the first switch and a second duty cycle of the negative output node is controller by a duty cycle of the second switch.

In another example of the above embodiment, a control input of the first transistor and a control input of the second transistor are connected to a positive terminal of a voltage in source, and wherein a negative terminal of the voltage in source is connected to the fourth node.

In another example of any the above embodiments a control input of the first transistor and a control input of the second transistor are connected to a positive terminal of a voltage in source, and wherein a negative terminal of the voltage in source is connected to the fourth node.

In another example of any the above embodiments the first transistor and the second transistor are MOSFETs.

In another example of any the above embodiments the first switch is a MOSFET.

In another example of any the above embodiments the inductor connecting the first node to the positive output node is the sole inductor.

In another example of any the above embodiments the positive output node is connected to the return via at least one capacitor, and via a first load.

In another example of any the above embodiments the at least one capacitor includes a plurality of capacitors.

In another example of any the above embodiments the active dual output buck converter is a component of a printed circuit board.

In another example of any the above embodiments the active dual output buck converter is providing two regulated output voltages.

According to another embodiment, a method for providing an active dual output buck converter includes providing an direct current (DC) input configured to be connected to an DC power source, a first switch connecting the DC input to a first node, a second switch connecting the first node to a return node, wherein the second switch is an active AC switch, an inductor connecting the first node to a positive output node, a diode connecting the first node to a negative output node, and wherein a duty cycle of the positive output node is controlled by a duty cycle of the first switch and a second duty cycle of the negative output node is controlled by a duty cycle of the second switch.

In another example of any the above embodiments the second switch comprises a first transistor connecting the first node to a fourth node, and a second transistor connecting the fourth node to the return node.

In another example of any the above embodiments a control input of the first transistor and a control input of the second transistor are connected to a positive terminal of a voltage in source, and wherein a negative terminal of the voltage in source is connected to the fourth node.

In another example of any the above embodiments the first transistor and the second transistor are MOSFETs.

In another example of any the above embodiments the first switch is a MOSFET.

In another example of any the above embodiments the inductor connecting the first node to the positive output node is the sole inductor.

In another example of any the above embodiments the positive output node is connected to the return via at least one capacitor, and via a load.

In another example of any the above embodiments the at least one capacitor is a plurality of capacitors.

In another example of any the above embodiments the active dual output buck converter is a component of a printed circuit board.

In another example of any the above embodiments the active dual output buck converter is a component of a processor chip.

Additional features and advantages are realized through the techniques of the present disclosure. Other embodiments and aspects of the disclosure are described in detail herein and are considered a part of the claimed disclosure. For a better understanding of the disclosure with the advantages and the features, refer to the description and to the drawings.

### BRIEF DESCRIPTION OF THE SEVERAL VIEWS OF THE DRAWINGS

For a more complete understanding of this disclosure, reference is now made to the following brief description, taken in connection with the accompanying drawings and detailed description, wherein like reference numerals represent like parts:

FIG. 1 is a highly schematic printed circuit board including an actively controlled DC to DC converter;

FIG. 2 is a schematic view of an DC to DC converter that could be used in the circuit of FIG. 1;

FIG. 3 is a more detailed view of the DC to DC converter of FIG. 2;

FIG. 4 is yet a more detailed view of the DC to DC converter of FIGS. 2 and 3; and

FIG. 5 is an example Switch-Node waveform for the converters of FIGS. 2-4.

### DETAILED DESCRIPTION

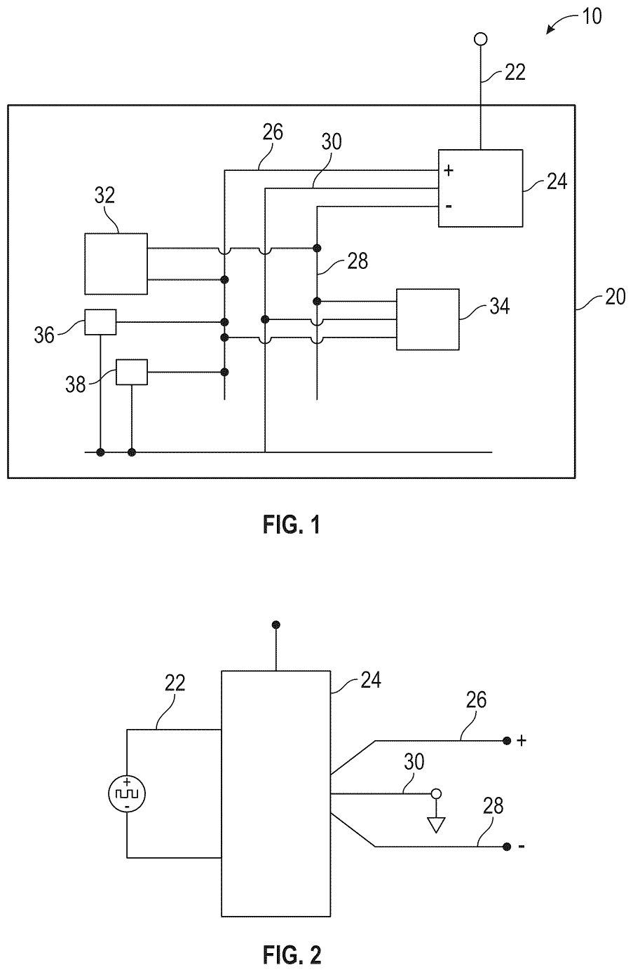

FIG. 1 schematically illustrates an example electronic component 10 having a printed circuit board 20. The printed circuit board 20 includes a DC power input 22 providing DC power to an active dual output buck converter 24. The active dual output buck converter 24 provides a positive voltage rail 26, a negative voltage rail 28 and a return rail 30. FIG. 2 provides a highly schematic view of the converter 24 of FIG. 1 isolated from the context of the printed circuit board 20. Multiple sub-components 32, 34, 36, 38 are connected to one or more of the voltage rails 24, 26, 30 as necessary for a given sub component. Certain sub-components 34 (e.g. an op-amp) require a positive and a negative input connection, and thus require a positive and negative voltage rail.

By way of example, positive and negative voltage rails 26, 28 are required for many sensor applications and are particularly important for op-amp based circuits.

Providing both positive and negative voltage rails from a single converter 24 saves volume in space constrained design environments, such as a printed circuit board and/or a processing chip. The active dual output buck converter 24 utilizes an DC-DC-switch topology to regulate both a positive and negative voltage rail 24. The dual output buck converter 24 achieves this by using an DC-DC-switch based topology.

With continued reference to FIGS. 1 and 2, FIG. 3 illustrates a detailed topology of an active dual output buck converter (converter 300) according to one example. The active dual output buck converter 300 includes an input from a DC source 302, a first switch 304 connecting a positive output of the DC source 302 to a node N1 and defining a first duty cycle for the converter 300, a diode 306 defining a second duty cycle of the converter 300 and connecting the node N1 to a second node N2. The second node N2 provides a negative voltage output 308 of the converter 300 and is connected to a neutral 310 via a first capacitor 312 and a resistor 314. Each of the switches 304, and the switching elements within the AC switch 326 are metal oxide semiconductor field effect (MOSFET) transistors.

An inductor 316 connects node N1 to a third node N3 and the third node N3 operates as the positive voltage output 318. The third node N3 is connected to the return 310 via a second and third capacitor 320, 322 and a resistor 324. In alternative examples, the second and third capacitor 320, 322 can be a single capacitor or any number of additional capacitors similarly arranged.

Referring again to the first node N1, the first node N1 is connected to the return 310 via an active AC switch 326. The active AC switch 326 operates as a third duty cycle for the converter 300.

A state of the first switch 304 is controlled via a pulse voltage in source 332 with a positive end connected to a control input of the switch 304 via a resistor 334 and a negative end of the pulse voltage in source being connected to the first node N1. A state of the second switch (active AC switch 326) is controlled via a second pulse voltage in source 336. The second pulse voltage in source 336 provides a positive end connection and a negative end connection to the third switch 326.

The high/low states of both the first pulse voltage in source 332 and the second pulse voltage in source 336 are controlled via a controller 301 according to any known control scheme in order to provide switching which defines the first and third duty cycles by turning the switches 304, 326. As the second duty cycle is controlled via the diode 306, the second duty cycle is passive according to the voltage differential between the neutral 310 and the first node N1.

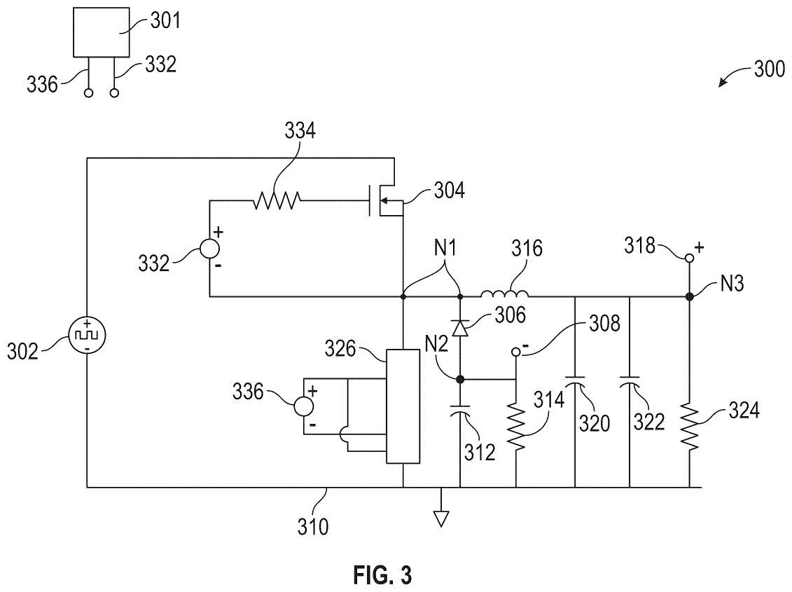

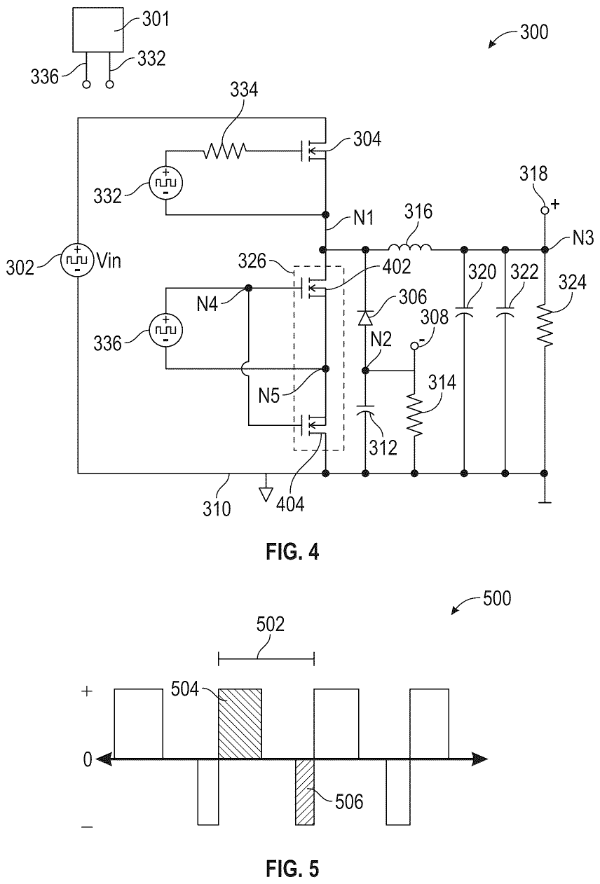

With continued reference to FIG. 3, FIG. 4 illustrates the converter 300 of FIG. 3, with one example topology of the second switch 326 illustrated in detail. The second switch 326 includes a highside switch 402 connecting the first node N1 to a fifth node N5 and a lowside switch 404 connecting the fifth node N5 to neutral 310. An open (non-conducting)/closed (conducting) state of each switch 402, 404 is controlled by a control input connected to a fourth node N4. The fourth node N4 is also connected to a positive side of the voltage in source 336, while a negative side of the voltage in source 336 is connected to the fifth node N5.

During operation of the converter 300, the first voltage in source 332 controls the first duty cycle, defined by the state of the first switch 304. A gate resistor 334 limits current in and out of the first switch 304 and the second pulse voltage in source 336 controls the second and third duty cycles, defined by the actively controlled AC switch 326 and the diode 316.

The converter 300 includes an input voltage, defined as the voltage output by the DC source 302 (Vin) and provides a positive output voltage 318 (Vout) and a negative output voltage 308 (NVout), with the voltage being defined according to:

$$V out = {V in}^{*} D 1 - {NV out}^{*} D 2$$

Where D1 is the first duty cycle and D2 is the second duty cycle. Similarly, the currents at the outputs 308, 318 are defined according to:

$$Ineg = D {2}^{*} Io$$

Where Ineg is the current at the negative voltage output 308 and Io is the current at the positive voltage output 318. The converter 300 is therefore defined by three duty cycles (D1, D2, D3) that are generally expressed according to:

$$\begin{matrix}D 1 = {( 1 / Vin )}^{*} ( Vo - {Vn}^{*} ( Ineg / Io ) ) \\ D 2 = Ineg / Io \\ D 3 = 1 - ( D 1 + D 2 )\end{matrix}$$

Where D1 is a duty cycle of the first switch 304, D2 is a duty cycle of the active AC switch 326, and D3 is a duty cycle across the diode 306.

The specific topology described in FIGS. 2-4 provides the dual output (positive and negative) using a single inductor 316 with a smaller component count, a smaller packaging requirement, and a lower power requirement than other converter designs including the prior art converters using an DC to DC converter for the positive output and an in line buck converter for the negative output.

In the specific example of FIGS. 2-4,

$${D}_{1} = \frac{{V}_{OUT}}{{V}_{IN}} + \frac{( \vert {NV}_{OUT} \vert + {V}_{D} ) * {D}_{2}}{{V}_{IN}}$$

$${D}_{2} = \frac{\vert {NV}_{OUT} \vert}{{I}_{S} * {R}_{L ( n e g )}}$$

Where Is is the current of the inductor 316, and NVout is the inductor current averaged over the D2 interval times the load resistance. In one example, the negative output capacitor (capacitor 312) is peak charged and is designed at a large enough capacitance to holdup the output (NVout) during a diode 306 off state (D′).

Within a typical switching power supply (having only a positive output voltage) there is a 0 voltage to positive voltage square wave feeding an inductance/capacitance (LC) filter. The inductance filters the current and the capacitance filters the voltage. The output voltage, of the switching power supply, is the peak voltage multiplied by the duty cycle of the switch power supply. Thus, if the duty cycle is 40%, then the output voltage of the switching power supply is 12V*0.4, or 4.8V.

The active dual output buck converter 300 operates similar to the typical switching power supply, with the additional consideration of the negative output voltage 308. FIG. 5 illustrates an example square wave 500 with an example period 502. The square wave defines a first area 504 under the wave 500 during a time where the wave 500 is above 0 (+), and a second area 506 during a time where the wave 500 is below 0 (−). The time at negative voltage (the area 506 where the wave 500 is below 0) takes away from the area 504 of positive voltage, and the total duty cycle of the wave is the combined time of the area 504 above 0 and the area 506 below 0. The area 506 below 0 is necessary to provide the negative output 308. As a result, the duty cycle of the first switch D1 is increased to compensate for the negative area 506. The illustrated gap between the area 504 above 0 and the area 506 below zero may be any size (or non existent), and the area below 506 below 0 may occur at any portion of the wave 500, provided the area 506 below 0 does not overlap with the area above 0.

The topology of FIGS. 2-4 is particularly useful in applications requiring low duty cycles for the first switch 304 (e.g., a low positive power requirement) because it provides extra (spare) duty cycle availability to adapt for sudden changes in an input line or load current and provides enough duty cycle to generate the negative output voltage.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form detailed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the various embodiments with various modifications as are suited to the particular use contemplated.

While the preferred embodiments have been described, it will be understood that those skilled in the art, both now and in the future, may make various improvements and enhancements which fall within the scope of the claims which follow. These claims should be construed to maintain the proper protection for the disclosure as first described.

What is claimed is:

1. An active dual output buck converter comprising:
an alternating current (DC) input configured to be connected to an DC power supply;
a first switch connecting the DC input to a first node;
a second switch connecting the first node to a return node, wherein the second switch is an active AC switch;
an inductor connecting the first node to a positive output node;
a diode connecting the first node to a negative output node; and
wherein a duty cycle of the positive output node is controlled by a duty cycle of the first switch and a second duty cycle of the negative output node is controlled by a duty cycle of the second switch.

2. The active dual output buck converter of claim 1, wherein the second switch comprises a first transistor connecting the first node to a fourth node, and a second transistor connecting the fourth node to the return node.

3. The active dual output buck converter of claim 2, wherein a control input of the first transistor and a control input of the second transistor are connected to a positive terminal of a voltage in source, and wherein a negative terminal of the voltage in source is connected to the fourth node.

4. The active dual output buck converter of claim 2, wherein the first transistor and the second transistor are MOSFETs.

5. The active dual output buck converter of claim 1, wherein the first switch is a MOSFET.

6. The active dual output buck converter of claim 1, wherein the inductor connecting the first node to the positive output node is the sole inductor.

7. The active dual output buck converter of claim 1, wherein the positive output node is connected to the return via at least one capacitor, and via a first load.

8. The active dual output buck converter of claim 7 wherein the at least one capacitor includes a plurality of capacitors.

9. The active dual output buck converter of claim 1, wherein the active dual output buck converter is a component of a printed circuit board.

10. The active dual output buck converter of claim 1, wherein the active dual output buck converter is providing two regulated output voltages.

11. A method for providing an active dual output buck converter comprising:
providing an direct current (DC) input configured to be connected to an DC power supply, a first switch connecting the DC input to a first node, a second switch connecting the first node to a return node, wherein the second switch is an active AC switch, an inductor connecting the first node to a positive output node, a diode connecting the first node to a negative output node; and
wherein a duty cycle of the positive output node is controlled by a duty cycle of the first switch and a second duty cycle of the negative output node is controlled by a duty cycle of the second switch.

12. The method of claim 11, wherein the second switch comprises a first transistor connecting the first node to a fourth node, and a second transistor connecting the fourth node to the return node.

13. The method claim 12, wherein a control input of the first transistor and a control input of the second transistor are connected to a positive terminal of a voltage in source, and wherein a negative terminal of the voltage in source is connected to the fourth node.

14. The method of claim 12, wherein the first transistor and the second transistor are MOSFETs.

15. The method of claim 11, wherein the first switch is a MOSFET.

16. The method of claim 11, wherein the inductor connecting the first node to the positive output node is the sole inductor.

17. The method of claim 11 wherein the positive output node is connected to the return via at least one capacitor, and via a load.

18. The method of claim 17, wherein the at least one capacitor is a plurality of capacitors.

19. The method of claim 11, wherein the active dual output buck converter is a component of a printed circuit board.

20. The method of claim 11, wherein the active dual output buck converter is a component of a processor chip.
